(19) United States
(12) Patent Application Publication
(10) Pub. No.: US 2025/0015540 A1
(43) Pub. Date: Jan. 9, 2025

(54) ELECTRICAL CONNECTOR, MATING CONNECTOR AND ELECTRICAL CONNECTOR ASSEMBLY WITH IMPROVED MATING FEATURES

(71) Applicant: DONGGUAN LUXSHARE TECHNOLOGIES CO., LTD, Dongguan City (CN)

(72) Inventors: Hengshan CHENG, Dongguan City (CN); Tao SONG, Dongguan City (CN); Hongji CHEN, Dongguan City (CN)

(73) Assignee: DONGGUAN LUXSHARE TECHNOLOGIES CO., LTD, Dongguan City (CN)

(21) Appl. No.: 18/897,335

(22) Filed: Sep. 26, 2024

Related U.S. Application Data
(63) Continuation-in-part of application No. 17/834,523, filed on Jun. 7, 2022.
(63) Continuation-in-part of application No. 17/839,873, filed on Jun. 14, 2022.
(63) Continuation-in-part of application No. 17/958,829, filed on Oct. 3, 2022.

(30) Foreign Application Priority Data
Jun. 16, 2021 (CN) 202110665729.0
Jun. 16, 2021 (CN) 202121340213.0
Oct. 12, 2021 (CN) 202122460467.2
Aug. 29, 2024 (CN) 202411205338.0

(51) Int. Cl. H01R 13/639; H01R 12/71; H01R 12/75; H01R 13/635

(52) U.S. Cl. CPC H01R 13/639; H01R 13/635; H01R 12/716; H01R 12/75

(57) ABSTRACT

An electrical connector includes an insulating body and a number of conductive terminals. The insulating body includes a first extension portion and a second extension portion. The first extension portion includes a first extension protrusion, a second extension protrusion and a first slot. The second extension portion includes a third extension protrusion, a fourth extension protrusion and a second slot. The first extension protrusion, the second extension protrusion, the third extension protrusion and the fourth extension protrusion are configured to be inserted into a mating connector. The first slot and the second slot are configured to snap with the mating connector. The mating connector includes a first accommodating sub-groove, a second accommodating sub-groove, a third accommodating sub-groove and a fourth accommodating sub-groove configured to lock with the electrical connector. An electrical connector assembly is also disclosed.

### CROSS-REFERENCE TO RELATED APPLICATIONS

This patent application claims priority of a Chinese Patent Application No. 202411205338.0, filed on Aug. 29, 2024 and titled “ELECTRICAL CONNECTOR, MATING CONNECTOR AND ELECTRICAL CONNECTOR ASSEMBLY”, and is a continuation-in-part of U.S. patent application Ser. No. 17/834,523, filed on Jun. 7, 2022 and titled “STRAP CONNECTOR AND ASSEMBLY THEREOF WITH ENHANCED MATING RETENTION FORCE”, which claims priority of a Chinese Patent Application No. 202110665729.0, filed on Jun. 16, 2021, a continuation-in-part of U.S. patent application Ser. No. 17/839,873, filed on Jun. 14, 2022 and titled “CONNECTOR AND ASSEMBLY THEREOF WITH FOOLPROOF STRUCTURE”, which claims priority of a Chinese Patent Application No. 202121340213.0, filed on Jun. 16, 2021, and a continuation-in-part of U.S. patent application Ser. No. 17/958,829, filed on Oct. 3, 2022 and titled “PULL STRAP CONNECTOR AND ASSEMBLY THEREOF WITH IMPROVED LOCKING FEATURES”, which claims a priority of a Chinese Patent Application No. 202122460467.2, filed on Oct. 12, 2021, the entire content of which is incorporated herein by reference.

### TECHNICAL FIELD

The present disclosure relates to an electrical connector, a mating connector and an electrical connector assembly, which belongs to the technical field of connectors.

### BACKGROUND

An existing connector assembly generally includes an electrical connector and a mating connector mating with the electrical connector. The electrical connector includes an insulating body, a plurality of conductive terminals, a locking piece and a pulling strap. The conductive terminals are received in the insulating body. The locking piece is located on one side of the insulating body. The pulling strap is connected to the locking piece. The locking piece includes a hook located on one side of the insulating body. The mating connector includes a slot for mating with the hook.

However, the existing connector assembly of the relevant art has a single-side locking design which has a weak retention force between the electrical connector and the mating connector, and is prone to loosening or tilting due to an external force, thereby affecting the stability of data transmission.

### SUMMARY

An object of the present disclosure is to provide an electrical connector, a mating connector and an electrical connector assembly with improved mating reliability.

In order to achieve the above object, the present disclosure adopts the following technical solution: an electrical connector, including: an insulating body, the insulating body including a main body, a tongue plate protruding from the main body along a mating direction, and a first extension portion and the second extension portion which protrude from the main body along the mating direction; the first extension portion and the second extension portion being located on two sides of the main body; and a plurality of conductive terminals, each conductive terminal including a mating portion exposed to the tongue plate; wherein the first extension portion includes a first extension protrusion, a second extension protrusion, and a first slot located between the first extension protrusion and the second extension protrusion; the second extension portion includes a third extension protrusion, a fourth extension protrusion, and a second slot located between the third extension protrusion and the fourth extension protrusion; the first extension protrusion, the second extension protrusion, the third extension protrusion and fourth extension protrusion are configured to be at least partially inserted into a mating connector; the first slot and the second slot are configured to at least partially accommodate the mating connector, so that the electrical connector and the mating connector are engaged with each other.

In order to achieve the above object, the present disclosure adopts the following technical solution: a mating connector, including: a mating insulating body, the mating insulating body including a plurality of wall portions and a mating slot surrounded by the plurality of wall portions; the plurality of wall portions including a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive an electrical connector; a plurality of mating terminals, the plurality of mating terminals being fixed to the mating insulating body; each mating terminal including an elastic mating arm extending into the mating slot and being configured to contact the electrical connector; and a metal shell, the metal shell at least partially covering the mating insulating body; the metal shell including a first side wall, a second side wall disposed opposite to the first side wall, a first connecting wall connecting one side of the first side wall and one side of the second side wall, and a second connecting wall connecting another side of the first side wall and another side of the second side wall; wherein the mating connector defines a first accommodating groove located between the first connecting wall portion and the first connecting wall, and a second accommodating groove located between the second connecting wall portion and the second connecting wall; the mating connector includes a first protrusion located in the first accommodating groove; the first protrusion divides the first accommodating groove into a first accommodating sub-groove and a second accommodating sub-groove; the mating connector includes a second protrusion located in the second accommodating groove; the second protrusion divides the second accommodating groove into a third accommodating sub-groove and a fourth accommodating sub-groove; the first accommodating sub-groove, the second accommodating sub-groove, the third accommodating sub-groove and the fourth accommodating sub-groove are configured to at least partially receive the electrical connector.

In order to achieve the above object, the present disclosure adopts the following technical solution: an electrical connector assembly, including: an electrical connector, the electrical connector, including: an insulating body, the insulating body including a main body, a tongue plate protruding beyond the main body along a mating direction, and a first extension portion and the second extension portion which protrude beyond the main body along the mating direction; the first extension portion and the second extension portion being located on two sides of the main body, respectively; and a plurality of conductive terminals, each conductive terminal including a mating portion exposed to the tongue plate; wherein the first extension portion includes a first extension protrusion, a second extension protrusion, and a first slot located between the first extension protrusion and the second extension protrusion; the second extension portion includes a third extension protrusion, a fourth extension protrusion, and a second slot located between the third extension protrusion and the fourth extension protrusion; and a mating connector, the mating connector, including: a mating insulating body, the mating insulating body including a plurality of wall portions and a mating slot surrounded by the plurality of wall portions; the plurality of wall portions including a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive the electrical connector; a plurality of mating terminals, the plurality of mating terminals being fixed to the mating insulating body; each mating terminal including an elastic mating arm extending into the mating slot and being configured to contact the mating portion of the electrical connector; and a metal shell, the metal shell at least partially covering the mating insulating body; the metal shell including a first side wall, a second side wall disposed opposite to the first side wall, a first connecting wall connecting one side of the first side wall and one side of the second side wall, and a second connecting wall connecting another side of the first side wall and another side of the second side wall; wherein the mating connector defines a first accommodating groove located between the first connecting wall portion and the first connecting wall, and a second accommodating groove located between the second connecting wall portion and the second connecting wall; the mating connector includes a first protrusion located in the first accommodating groove; the first protrusion divides the first accommodating groove into a first accommodating sub-groove and a second accommodating sub-groove; the mating connector includes a second protrusion located in the second accommodating groove; the second protrusion divides the second accommodating groove into a third accommodating sub-groove and a fourth accommodating sub-groove; when the electrical connector is inserted into the mating connector, the first extension protrusion, the second extension protrusion, the third extension protrusion and the fourth extension protrusion of the electrical connector are at least partially inserted into the first accommodating sub-groove, the second accommodating sub-groove, the third accommodating sub-groove and the fourth accommodating sub-groove of the mating connector, respectively.

Compared with the prior art, the electrical connector of the present disclosure is provided with the first extension protrusion, the second extension protrusion, the third extension protrusion and the fourth extension protrusion. The first extension protrusion, the second extension protrusion, the third extension protrusion and the fourth extension protrusion are configured to be at least partially inserted into the mating connector. The first slot and the second slot are configured to at least partially accommodate the mating connector, so that the electrical connector and the mating connector are engaged with each other. Through the above structures, the present disclosure improves the mating reliability of the electrical connector and the mating connector, reduces the risk of loosening or tilting of the electrical connector and the mating connector, and improves the stability of data transmission.

Besides, the mating connector of the present disclosure defines the first accommodating sub-groove, the second accommodating sub-groove, the third accommodating sub-groove and the fourth accommodating sub-groove which are configured to at least partially receive the electrical connector. Through the above structures, the present disclosure improves the mating reliability of the electrical connector and the mating connector, reduces the risk of loosening or tilting of the electrical connector and the mating connector, and improves the stability of data transmission.

The present disclosure further discloses an electrical connector assembly including the electrical connector and the mating connector, which has the respective beneficial effects of the electrical connector and the mating connector. Through the above structures, the present disclosure improves the mating reliability of the electrical connector and the mating connector, reduces the risk of loosening or tilting of the electrical connector and the mating connector, and improves the stability of data transmission.

### BRIEF DESCRIPTION OF DRAWINGS

FIG. 1 is a schematic perspective view of an electrical connector assembly in accordance with a first embodiment of the present disclosure, in which an electrical connector is mated with a mating connector, and the mating connector is mounted on a circuit board;

FIG. 2 is a perspective view of FIG. 1 from another angle;

FIG. 3 is a rear view of FIG. 1;

FIG. 4 is a partially exploded perspective view of FIG. 1;

FIG. 5 is a partially exploded perspective view of FIG. 4 from another angle;

FIG. 6 is a right side view of a mating state of the mating connector and the electrical connector without the circuit board;

FIG. 7 is a right view of the mating connector and the electrical connector in a separated state without the circuit board;

FIG. 8 is a further perspective exploded view of the electrical connector assembly of the present disclosure;

FIG. 9 is a further perspective exploded view of the electrical connector in FIG. 8;

FIG. 10 is a further perspective exploded view of the electrical connector in FIG. 9;

FIG. 11 is a top view of the electrical connector in FIG. 4;

FIG. 12 is a schematic cross-sectional view taken along line D-D in FIG. 6;

FIG. 13 is a further perspective exploded view of the mating connector in FIG. 8;

FIG. 14 is an exploded perspective view of a mating insulating body and mating terminals in FIG. 13;

FIG. 15 is an enlarged view of circled portion A in FIG. 2;

FIG. 16 is a perspective view of an electrical connector assembly in accordance with a second embodiment of the present disclosure, in which an electrical connector is mated with a mating connector, and the mating connector is mounted on a circuit board;

FIG. 17 is a perspective view of FIG. 16 from another angle;

FIG. 18 is a front view of FIG. 16;

FIG. 19 is a rear view of FIG. 16;

FIG. 20 is a right view of FIG. 16;

FIG. 21 is a left view of FIG. 16;

FIG. 22 is an exploded perspective view of the electrical connector and the mating connector in FIG. 16;

FIG. 23 is an exploded perspective view of FIG. 22 from another angle;

FIG. 24 is a partial enlarged view of circled portion E in FIG. 22;

FIG. 25 is a partial enlarged view of circled portion F in FIG. 22;

FIG. 26 is a partial enlarged view of circled portion G in FIG. 23;

FIG. 27 is a partial enlarged view of circled portion H in FIG. 23;

FIG. 28 is a partially exploded perspective view of the electrical connector shown in FIG. 22;

FIG. 29 is a partially exploded perspective view of FIG. 28 from another angle;

FIG. 30 is a partially exploded perspective view of the mating connector shown in FIG. 22;

FIG. 31 is a partially exploded perspective view of FIG. 30 from another angle;

FIG. 32 is a top view of the mating connector shown in FIG. 22;

FIG. 33 is a schematic cross-sectional view taken along line K1-K1 in FIG. 20, in which the circuit board is not shown;

FIG. 34 is a schematic cross-sectional view taken along line K2-K2 in FIG. 20, in which the circuit board is not shown;

FIG. 35 is a perspective view of the electrical connector and the mating connector in FIG. 22 in accordance with a third embodiment of the present disclosure; and

FIG. 36 is a perspective view of FIG. 35 from another angle.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

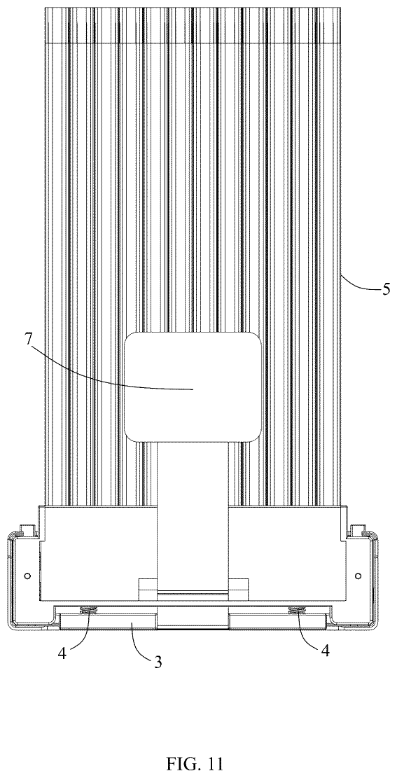

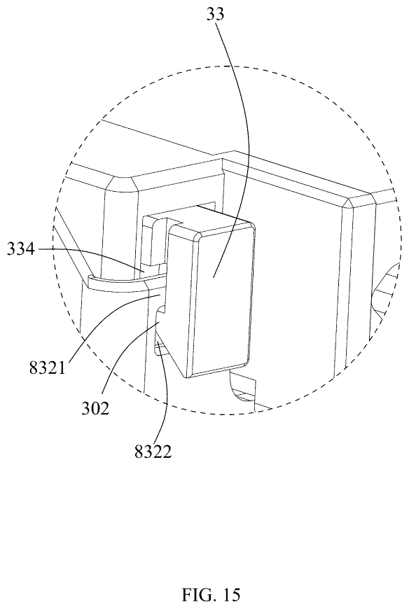

Referring to FIG. 1 to FIG. 15, the present disclosure discloses a connector assembly, which includes an electrical connector 100 and a mating connector 200 for matching with the electrical connector 100. In the illustrated embodiment of the present disclosure, the electrical connector 100 is a pull strap connector and a cable end connector. The mating connector 200 is a board-end connector and configured to be mounted on a circuit board 300. Referring to FIG. 4, the electrical connector 100 is configured to mate with the mating connector 200 along a mating direction B (for example, a top-to-bottom direction) to realize data transmission.

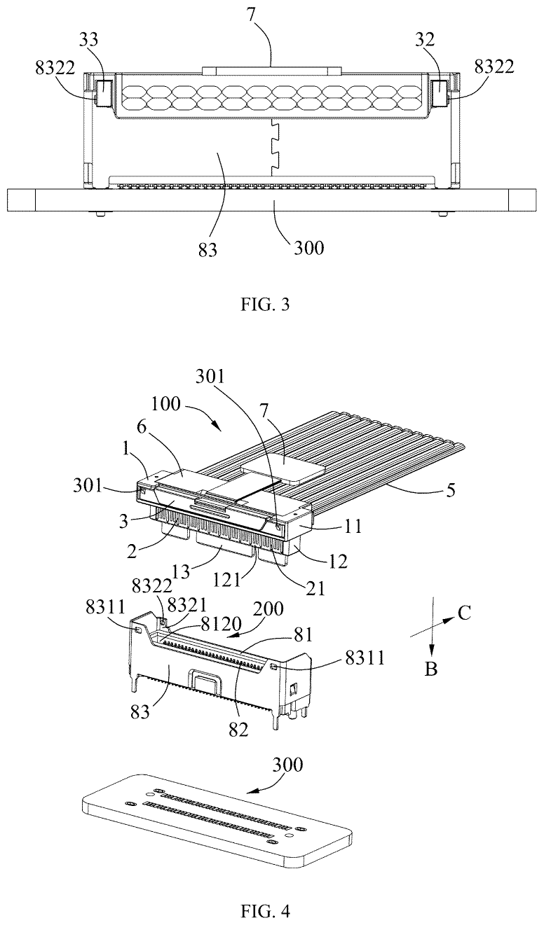

Referring to FIG. 3 to FIG. 15, the electrical connector 100 includes an insulating body 1, a plurality of conductive terminals 2 fixed to the insulating body 1, a movable component 3 installed on the insulating body 1, an elastic component 4 abutting against the movable component 3, a cable 5 electrically connected to the conductive terminal 2, a cover plate 6 that is fastened on the insulating body 1 and at least partially abuts against the cable 5, and a pull strap 7 connected to the movable component 3. The pull strap 7 is configured to drive the movable component 3 to overcome the force of the elastic component 4, so that the movable component 3 is able to move along a moving direction C (as shown in FIG. 3) perpendicular to the mating direction B.

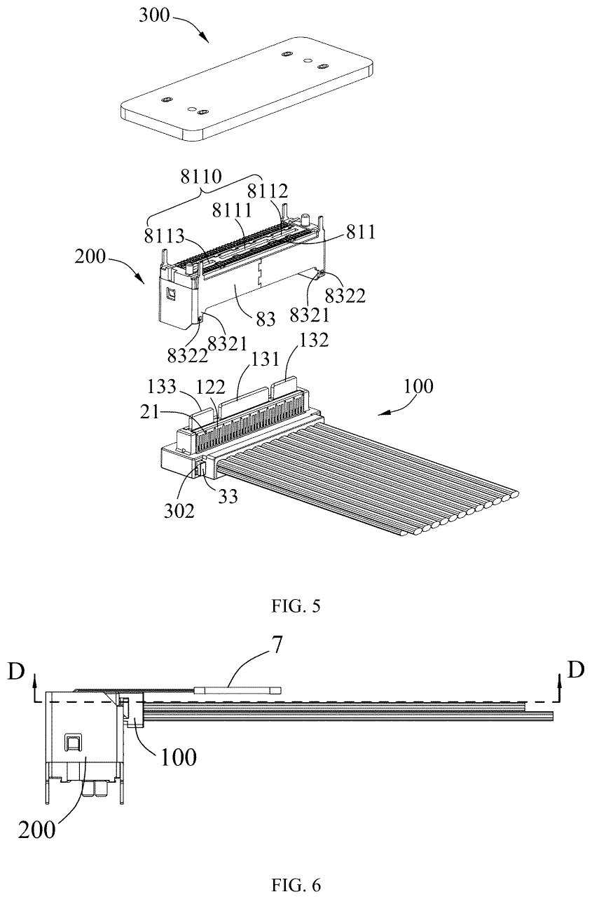

In the illustrated embodiment of the present disclosure, the insulating body 1 includes a main body 11, a tongue plate 12 protruding downwardly from the main body 11 along the mating direction B, and a positioning plate 13 further protruding downwardly from the tongue plate 12 along the mating direction B. In the illustrated embodiment of the present disclosure, a dimension of the main body 11 in a front-rear direction/a second direction, a dimension of the tongue plate 12 in the front-rear direction, and a dimension of the positioning plate 13 in the front-rear direction become smaller in sequence, so that the insulating body 1 is roughly of a stepped configuration. Referring to FIG. 4 and FIG. 5, the positioning plate 13 includes a first positioning piece 131 located in a middle, a second positioning piece 132 located on one side of the first positioning piece 131, and a third positioning piece 133 located on another side of the first positioning piece 131. The second positioning piece 132 is spaced apart from the first positioning piece 131. The third positioning piece 133 is spaced apart from the first positioning piece 131. A dimension of the first positioning piece 131 along a left-right direction/a first direction is larger than a dimension of the second positioning piece 132 along the left-right direction. The dimension of the first positioning piece 131 along the left-right direction is also larger than a dimension of the third positioning piece 133 along the left-right direction. It is known that, the left-right direction is perpendicular to both the top-bottom direction and the front-rear direction. In the illustrated embodiment of the present disclosure, a distance between the first positioning piece 131 and the second positioning piece 132 is different from a distance between the first positioning piece 131 and the third positioning piece 133. This arrangement prevents the electrical connector 100 from being inserted into the mating connector 200 at a wrong angle, so that a certain foolproof effect can be achieved.

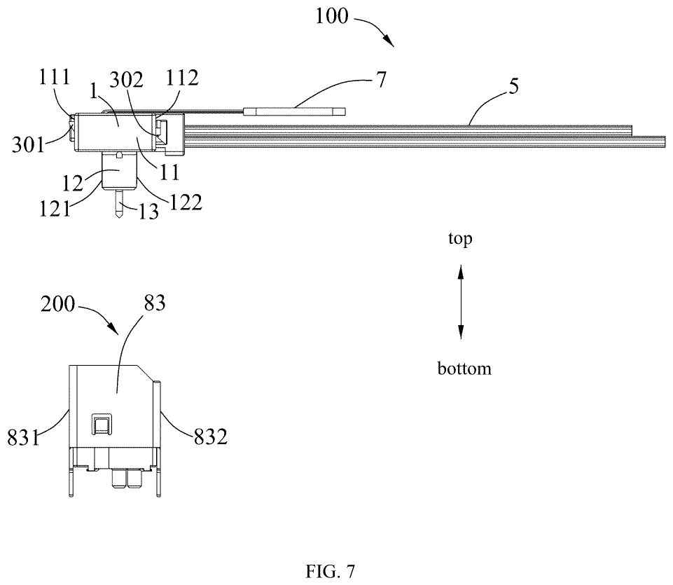

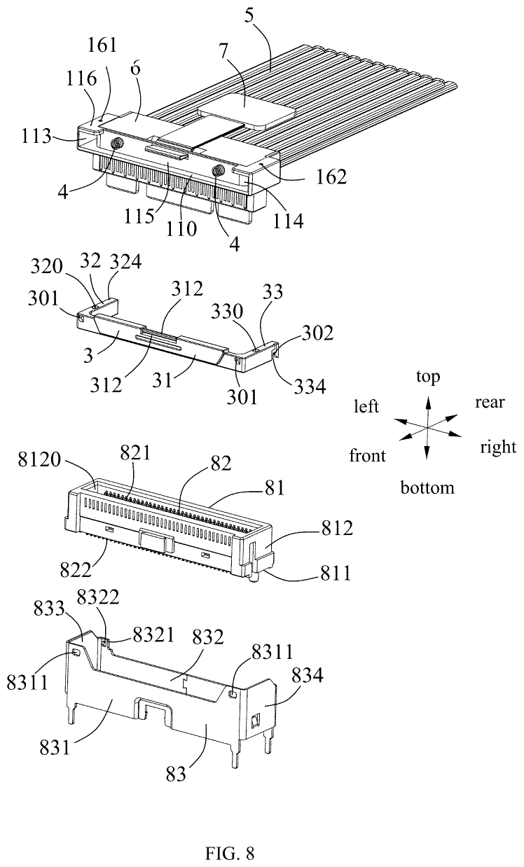

Referring to FIG. 7 and FIG. 8, the main body 11 includes a first end wall 111 (for example, a front end wall) and a second end wall 112 (for example, a rear end wall) opposite to the first end wall 111. The main body 11 further includes a receiving space 110 extending forwardly through the first end wall 111, a first receiving groove 113 located on one side (for example, a left side) of the receiving space 110, and a second receiving groove 114 located on another side (for example, a right side) of the receiving space 110. The receiving space 110 does not extend backwardly through the second end wall 112. The main body 11 includes an inner wall surface 115 exposed to the receiving space 110. The first receiving groove 113 and the second receiving groove 114 extend through the second end wall 112 along the moving direction C.

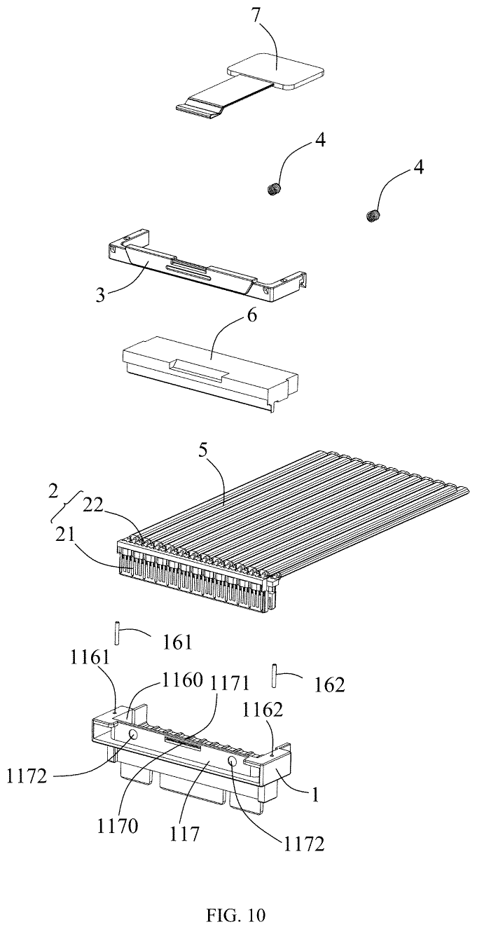

Referring to FIG. 10, the main body 11 includes a top surface 116, an opening 1160 extending upwardly through the top surface 116, a first mounting hole 1161 extending upwardly through the top surface 116 and located on one side of the opening 1160, and a second mounting hole 1162 extending upwardly through the top surface 116 and located on another side of the opening 1160. The main body 11 further includes a fixing plate 117 located between the first end wall 111 and the second end wall 112. In the illustrated embodiment of the present disclosure, the fixing plate 117 is a vertical plate. The fixing plate 117 includes a pull strap groove 1170 extending therethrough along the moving direction C, and a pull strap shaft 1171 located between an edge (for example, an upper edge) of the fixing plate 117 and the pull strap groove 1170. The pull strap 7 extends through the pull strap groove 1170 along the moving direction C from a connection with the movable component 3, and the pull strap is bent along the pull strap shaft 1171 and then extends out of the main body 11. The fixing plate 117 further includes at least one receiving hole 1172. In the illustrated embodiment of the present disclosure, the number of the receiving holes 1172 is two. The receiving holes 1172 are exposed on a surface of the fixing plate 117 and face towards the movable component 3. One end of the elastic component 4 is disposed in the receiving hole 1172 and another end of the elastic component 4 abuts against the movable component 3.

Referring to FIG. 4 to FIG. 7, the tongue plate 12 includes a first surface 121 and a second surface 122 which are disposed opposite to each other.

Referring to FIG. 10, each conductive terminal 2 includes a mating portion 21 exposed to the tongue plate 12 and a connection portion 22 electrically connected to the cable 5. In the illustrated embodiment of the present disclosure, the mating portions 21 are in the shape of flat plates, and are exposed to the first surface 121 and the second surface 122, respectively. In a first embodiment of the present disclosure, the conductive terminals 2 are insert-molded with the insulating body 1. Of course, in a second embodiment, the conductive terminals 2 can also be directly mounted to the insulating body 1; or in a third embodiment, the conductive terminals 2 and an insulating block are combined into a terminal module, and then the terminal module is mounted to the insulating body 1. The fixing method of the conductive terminals 2 and the insulating body 1 is well known to those of ordinary skill in the art, and will not be described in detail in the present disclosure.

In the illustrated embodiment of the present disclosure, the cable 5 extends beyond the main body 11 along the moving direction C.

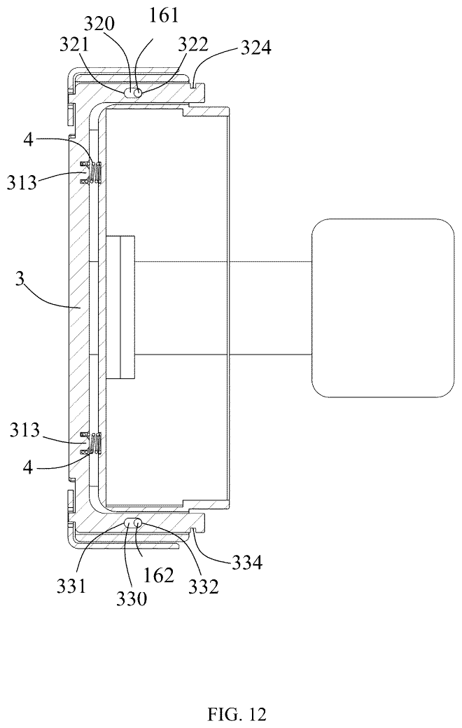

Referring to FIG. 8 and FIG. 12, the movable component 3 is at least partially installed to the main body 11. The movable component 3 includes a base 31, a first ejector rod 32 extending backwardly from one side of the base 31, and a second ejector rod 33 extending backwardly from another side of the base 31. The base 31 is accommodated in the receiving space 110. Most of the first ejector rod 32 is accommodated in the first receiving groove 113 except a rear end of the first ejector rod 32 which extends out of the first receiving groove 113. Most of the second ejector rod 33 is accommodated in the second receiving groove 114 except a rear end of the second ejector rod 33 which extends out of the second receiving groove 114. Both the first ejector rod 32 and the second ejector rod 33 can be referred to as ejector rods which extend from the first end wall 111 to the second end wall 112 with the rear ends thereof protruding beyond the second end wall 112.

The base 31 includes two first locking protrusions 301 located on two sides (for example, left and right sides) of the base 31, respectively, so as to improve the mating retention force. The first locking protrusions 301 are integrally formed with the main body 11 and extend forwardly beyond the first end wall 111. Of course, in another embodiment, the first locking protrusions 301 and the main body 11 can also be manufactured separately, and then assembled and fixed together. In this case, the first locking protrusions 301 can be made of a material, for example, a wear-resistant material with better structural strength, different from that of the main body 11. The base 31 further includes a pull strap connecting portion 312 to which the pull strap 7 is connected. The movable component 3 includes a transverse slot 311 extending through the base 31 along the moving direction C. The pull strap connecting portion 312 is located above the transverse slot 311. The pull strap connecting portion 312 is similar to a shaft portion, and is located between the transverse slot 311 and the edge (for example, the upper edge) of the base 31. One end of the pull strap 7 passes through the transverse slot 311 and is sleeved around the pull strap connecting portion 312.

In an alternative embodiment of the present disclosure, the number of the first locking protrusion 301 can be only one and the first locking protrusion 301 protrudes forwardly from a middle part of the first end wall 111. The first locking protrusion 301 has same distances to both the left-front side of the base 31 and the right-front side of the base 31.

In the illustrated embodiment of the present disclosure, the elastic component 4 is a compression spring installed between the base 31 and the inner wall surface 115 of the main body 11. The number of the compression springs is two, and the two compression springs are arranged side by side to improve the stability of the moving element 3 when the moving element 3 is moving. Besides, referring to FIG. 12, in order to better positioning the compression spring, the base 31 is further provided with a positioning post 313 which is at least partially inserted into the compression spring.

The movable component 3 further includes at least one second locking protrusion 302 protruding backwardly beyond the second end wall 112. In the illustrated embodiment of the present disclosure, the number of the second locking protrusions 302 is two. One of the second locking protrusions 302 is located at the rear end of the first ejector rod 32 away from the base 31. The one of the second locking protrusions 302 is located outside the first receiving groove 113 and protrudes toward the first receiving groove 113. A remaining one of the second locking protrusions 302 is located at the rear end of the second ejector rod 33 away from the base 31. The remaining one of the second locking protrusions 302 is located outside the second receiving groove 114 and protrudes toward the second receiving groove 114. The two second locking protrusions 302 are arranged in such a manner to improve an engagement force. The second locking protrusion 302 is integrally formed with a corresponding ejector rod to save cost. Of course, in another embodiment, the second locking protrusion 302 and the corresponding ejector rod can also be produced separately, and then assembled and fixed together. In this case, the second locking protrusion 302 can be made of a different material from that of the corresponding ejector rod. The first locking protrusions 301 and the second locking protrusions 302 are to lock with locking holes of the mating connector 200 to improve the mating retention force.

The two first locking protrusions 301 and the two second locking protrusions 302 are both arranged on the left side and the right side of the electrical connector, so that the present disclosure can realize a double-side locking purpose, thereby improving the mating retention force between the electrical connector and the mating connector. In an alternative embodiment, the only one first locking protrusion 301 is arranged on the middle part of the electrical connector and the two second locking protrusions 302 are arranged on the left side and the right side of the electrical connector, which can also realize the double-side locking purpose, thereby improving the mating retention force between the electrical connector and the mating connector.

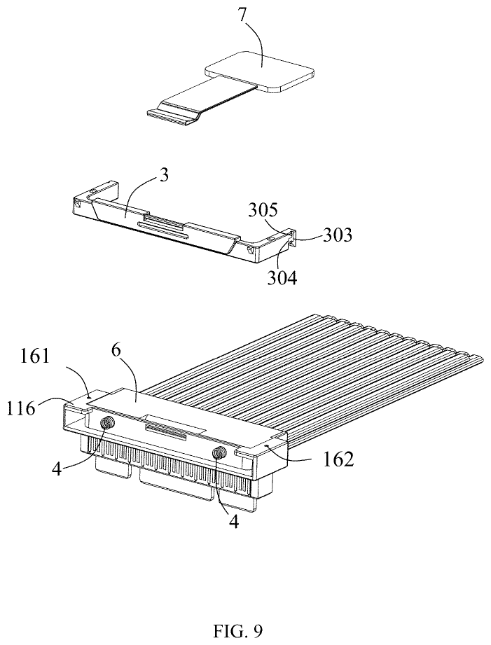

Referring to FIG. 8, FIG. 9 and FIG. 12, the first ejector rod 32 includes a first limiting groove 320 located in the middle, a first limiting surface 321 located at one end of the first limiting groove 320 along the moving direction C, and a second limiting surface 322 is located at another end of the first limiting groove 320 along the moving direction C. Compared with the second limiting surface 322, the first limiting surface 321 is closer to the first end wall 111.

Similarly, the second ejector rod 33 includes a second limiting groove 330 located in the middle, a third limiting surface 331 located at one end of the second limiting groove 330 along the moving direction C, and a fourth limiting surface 332 is located at another end of the second limiting groove 330 along the moving direction C. Compared with the fourth limiting surface 332, the third limiting surface 331 is closer to the first end wall 111.

Referring to FIG. 8, FIG. 9 and FIG. 12, the first ejector rod 32 further includes a first concave groove 324 located at a distal end (for example, a rear end) thereof, and the second ejector rod 33 further includes a second concave groove 334 located at a distal end (for example, a rear end) thereof. Both the first concave groove 324 and the second concave groove 334 are referred to as groove portions. Each groove portion has a first blocking wall 303 (for example, a rear blocking wall), a second blocking wall 304 (for example, a front lower blocking wall) and a third blocking wall 305 (for example, a front upper blocking wall). The second blocking wall 304 is located below the first blocking wall 303 to face the first blocking wall 303. The third blocking wall 305 is located above the first blocking wall 303 to face the first blocking wall 303. A large-diameter portion (not numbered) is formed between the first blocking wall 303 and the second blocking wall 304, and a small-diameter portion (not numbered) is formed between the first blocking wall 303 and the third blocking wall 305. A dimension of the small-diameter portion in the front-rear direction is smaller than a dimension of the large-diameter portion in the front-rear direction.

It should be noted that: in this embodiment, the groove portion extends vertically, and includes the small-diameter portion and the large-diameter portion. The small-diameter portion exists according to the manufacturing process of the groove portion. In another embodiment, the groove portion does not include the small-diameter portion and only includes the large-diameter portion, so that when the insertion plate portion 8321 is accommodated in the groove portion which only includes the large-diameter portion, the groove portion can move together with the movable component 3 in the front-rear direction, and the second locking protrusion 302 can be inserted into the second locking hole 8322 of the insertion plate portion 8321 for engagement.

The second locking protrusion 302 protrudes from the bottom of the first blocking wall 303 toward the second blocking wall 304. The second locking protrusion 302 is spaced from the second blocking wall 304 by a distance. Because the first locking protrusion 301 also protrudes from the rear to the front, the first locking protrusion 301 and the second locking protrusion 302 in the present disclosure have the same forward protruding direction. Referring to FIG. 4, FIG. 7 and FIG. 8, the forward protruding direction is opposite to the moving direction C.

The electrical connector 100 includes a first pin 151 fixed in the first mounting hole 1161 and a second pin 152 fixed in the second mounting hole 1162. The first pin 151 is inserted into the first limiting groove 320 and the second pin 152 is inserted into the second limiting groove 330. A dimension of the first limiting groove 320 is larger than a dimension of the first pin 151 along the moving direction C. A dimension of the second limiting groove 330 is larger than a dimension of the second pin 152 along the moving direction C. The first limiting surface 321 is used for engaging with the first pin 151, and the third limiting surface 331 is used for engaging with the second pin 152, so as to prevent the movable component 3 from moving excessively along the moving direction C. The second limiting surface 322 is used for engaging with the first pin 151, and the fourth limiting surface 332 is used for engaging with the second pin 152, so as to prevent the movable component 3 from returning excessively along an opposite direction of the moving direction C.

The cover plate 6 is accommodated and fixed in the opening 1160 of the main body 11, and the pull strap 7 extends out of the cover plate 6. The cover plate 6 presses against the connection between the cables 5 and the conductive terminals 2 (for example, welding portions of the cables 5 and the conductive terminals 2), so as to play a protection role.

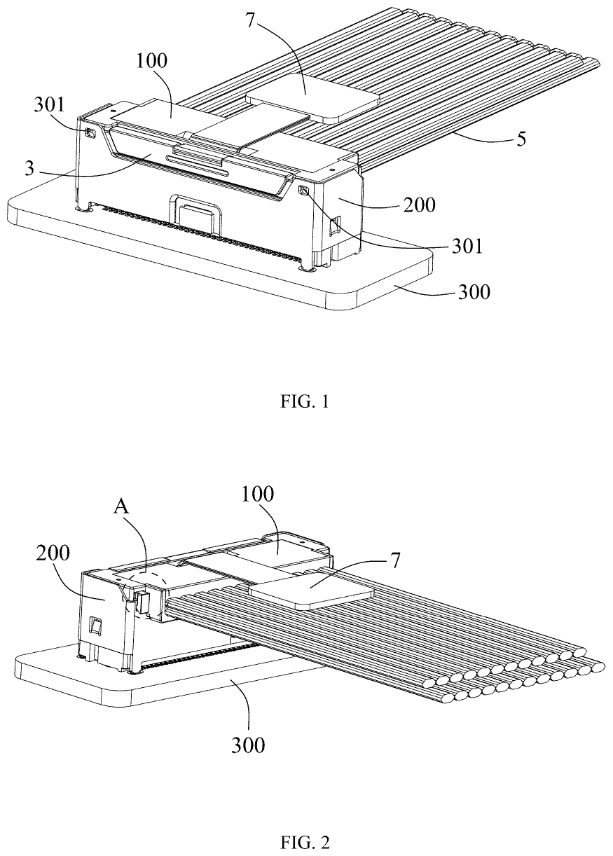

Referring to FIG. 2 to FIG. 8 and FIG. 13, the mating connector 200 includes a mating insulating body 81, a plurality of mating terminals 82 fixed to the mating insulating body 81, and a metal shell 83 enclosing the mating insulating body 81. The mating insulating body 81 includes a bottom wall 811 and a plurality of wall portions 812 perpendicular to the bottom wall 811. Referring to FIG. 5, the bottom wall 811 defines a positioning groove 8110 for accommodating the positioning plate 13. Specifically, the positioning groove 8110 includes a first positioning groove 8111 for accommodating the first positioning piece 131, a second positioning groove 8112 for accommodating the second positioning piece 132, and a third positioning groove 8113 for accommodating the third positioning piece 133. The first positioning groove 8111, the second positioning groove 8112 and the third positioning groove 8113 all extend through the bottom wall 811.

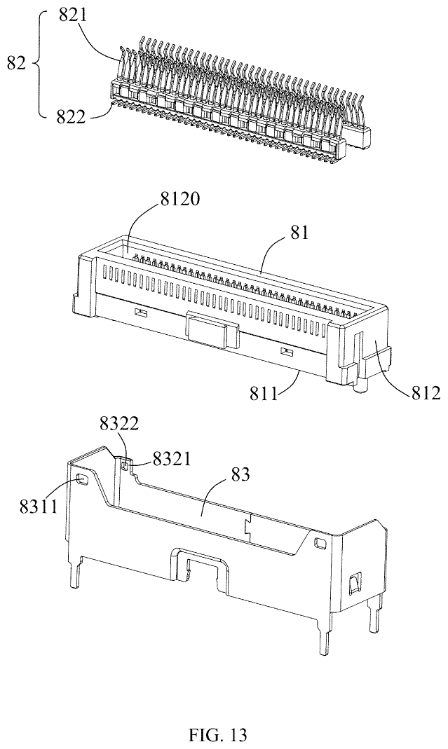

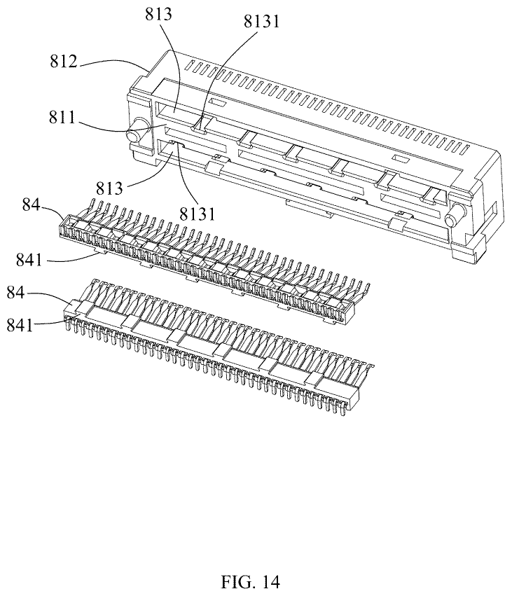

Referring to FIG. 13 and FIG. 14, the mating connector 200 includes a terminal fixing block 84 to which the mating terminals 82 are fixed. The mating insulating body 81 includes a terminal accommodating groove 813 in which the terminal fixing block 84 is fixed. The terminal fixing block 84 includes a first engaging portion 841. A second engaging portion 8131 is provided on one side of the terminal accommodating groove 813. The first engaging portion 841 and the second engaging portion 8131 are engaged with each other, so that the terminal fixing block 84 is fixed in the terminal accommodating groove 813. In the illustrated embodiment of the present disclosure, the first engaging portion 841 is a dovetail-shaped bump and the second engaging portion 8131 is a dovetail-shaped groove matching the dovetail-shaped bump.

In some embodiments, the number of the terminal fixing blocks 84 is two, and the two terminal fixing blocks 84 are symmetrical and spaced apart from each other. The mating terminals 82 are arranged in two symmetrical rows and the two rows of mating terminals 82 are fixed to the two terminal fixing blocks 84, respectively. Two terminal accommodating grooves 813 are provided, and the two terminal accommodating grooves 813 are symmetrical and spaced apart from each other. The two terminal accommodating grooves 813 are respectively formed between the bottom wall 811 and the two opposite wall portions 812. The two terminal fixing blocks 84 are fixed in the two terminal accommodating grooves 813. Each of the terminal fixing blocks 84 includes a plurality of first engaging portions 841. One side of each of the terminal accommodating grooves 813 includes a plurality of second engaging portions 8131 corresponding to the plurality of first engaging portions 841 respectively. Each of the first engaging portions 841 and the corresponding second engaging portions 8131 are engaged with each other, so that each terminal fixing block 84 is fixed in the corresponding terminal accommodating groove 813. The first engaging portions 841 are respectively disposed on the sides of the two terminal fixing blocks 84 facing each other. The second engaging portions 8131 are respectively disposed on opposite sides of the bottom wall 811 facing the two terminal accommodating grooves 813.

Referring to FIG. 8 and FIG. 13, the wall portions 812 are enclosed to form a mating slot 8120 for receiving the tongue plate 12. The mating terminals 82 are arranged in two rows. Each mating terminal 82 includes an elastic mating arm 821 and a mounting tail 822. The mounting tail 822 is used for being mounted on a circuit board 300. The elastic mating arm 821 extends into the mating slot 8120 for being in contact with the mating portion 21.

The metal shell 83 includes a first side wall 831, a second side wall 832, a first connecting wall 833, and a second connecting wall 834. The second side wall 832 is disposed opposite to the first side wall 831. The first connecting wall 833 connects one side of the first side wall 831 and one side of the second side wall 832. The second connecting wall 834 connects another side of the first side wall 831 and another side of the second side wall 832. The first side wall 831 defines a first locking hole 8311 engaged with the first locking protrusion 301. The second side wall 832 includes two insertion plate portion 8321 at a corner adjacent to the first connecting wall 833 and at a corner adjacent to the second connecting wall 834. That is to say, each of the left and right sides of the second side wall 832 includes one insertion plate portion 8321. The insertion plate portion 8321 defines a second locking hole 8322 matched with the second locking protrusion 302. The insertion plate portion 8321 is integrally formed on the second side wall 832. The insertion plate portion 8321 and the first connecting wall 833 are integrally formed, and the insertion plate portion 8321 and the second connecting wall 834 are also integrally formed without any gap. Therefore, the insertion plate portion 8321 has no elasticity.

When the electrical connector 100 is inserted into the mating connector 200, the positioning plate 13 is correspondingly accommodated in the positioning groove 8110, the tongue plate 12 is correspondingly accommodated in the mating slot 8120, and the mating portions 21 of the conductive terminals 2 correspondingly contact the elastic mating arms 821 of the mating terminals 82. With the insertion of the electrical connector 100, the inclined surface of the first locking protrusion 301 abuts against the first side wall 831, and the inclined surface of the second locking protrusion 302 abuts against the second side wall 832. The movable component 3 overcomes the force of the elastic component 4, and shrinks inward by a certain distance along the moving direction C. When the first locking protrusion 301 moves downwardly to the first locking hole 8311, and the second locking protrusion 302 moves downwardly to the second locking hole 8322, the elastic force of the elastic component 4 is released, so that the movable component 3 moves backwardly in the direction opposite to the moving direction C. The first locking protrusion 301 protrudes forwardly into the first locking hole 8311, and the second locking protrusion 302 protrudes forwardly and protrudes into the second locking hole 8322, thereby realizing the locking of the electrical connector 100 and the mating connector 200.

In the present disclosure, by providing the first locking protrusion 301 and the second locking protrusion 302 on two sides, two-side locking in the front-rear direction/the second direction can be achieved, thereby improving the mating reliability, and reducing the risk of the electrical connector 100 and the mating connector 200 becoming loose or tilted.

When the electrical connector 100 and the mating connector 200 need to be unlocked, an external force is applied to pull the pull strap 7, and the pull strap 7 generates a component force along the moving direction C, and the component force in this direction overcomes the force of the elastic component 4, so that the movable component 3 moves along the moving direction C. The first ejector rod 32 and the second ejector rod 33 move away from the insertion plate portion 8321 backwards, so that the second locking protrusion 302 and the second locking hole 8322 are disengaged from each other. The first locking protrusion 301 and the first locking hole 8311 are also separated from each other. In other words, the electrical connector 100 and the mating connector 200 are unlocked on two sides. As a result, the electrical connector 100 can be pulled out of the mating connector 200 by applying another force or by an upward component force exerted on the pull strap 7.

The insertion plate portion 8321 is accommodated in the large-diameter portion of the groove portion in both the locked state of the electrical connector 100 and the mating connector 200, and the unlocked state of the electrical connector 100 and the mating connector 200. When the movable component 3 drives the second locking protrusion 302 to move, and the second locking protrusion 302 cooperates with the second locking hole 8322, the insertion plate portion 8321 is in contact with the first blocking wall 303, and the insertion plate portion 8321 is separated from the second blocking wall 304. When the movable component 3 drives the second locking protrusion 302 to move, and the second locking protrusion 302 and the second locking hole 8322 are disengaged from each other, the insertion plate portion 8321 is in contact with the second blocking wall 304, and the insertion plate portion 8321 is separated from the first blocking wall 303.

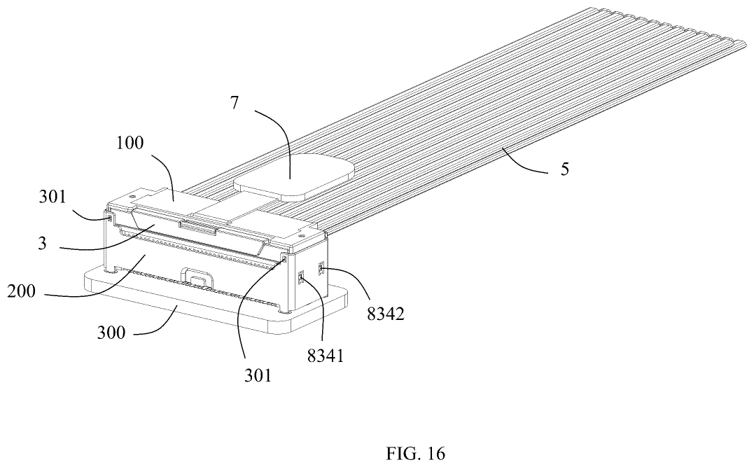

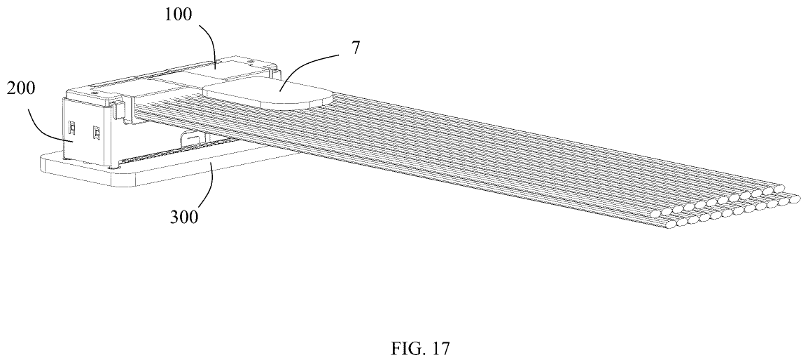

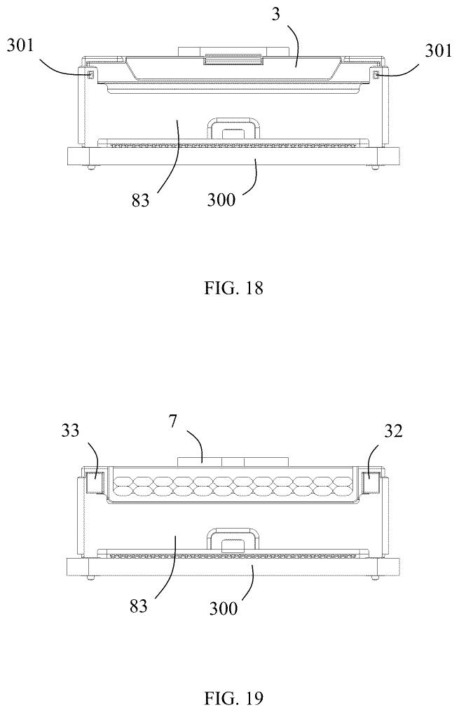

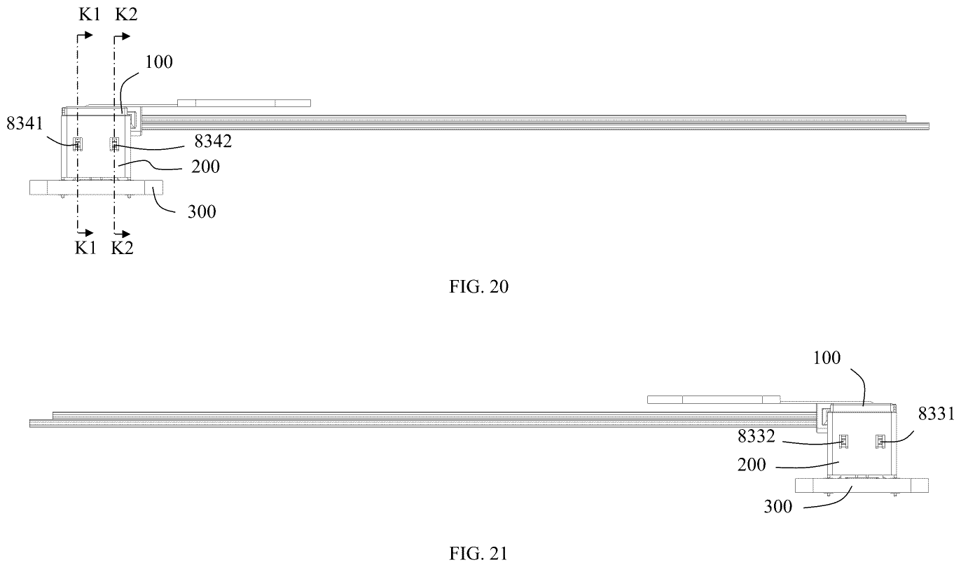

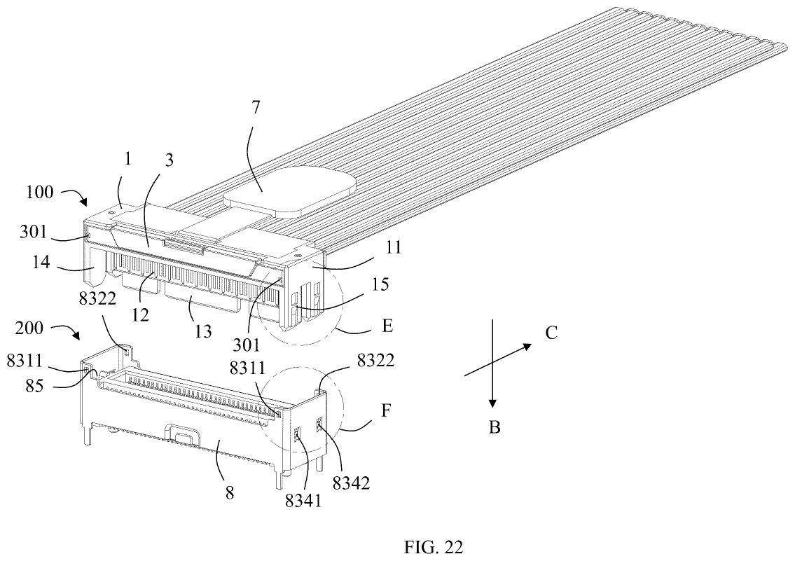

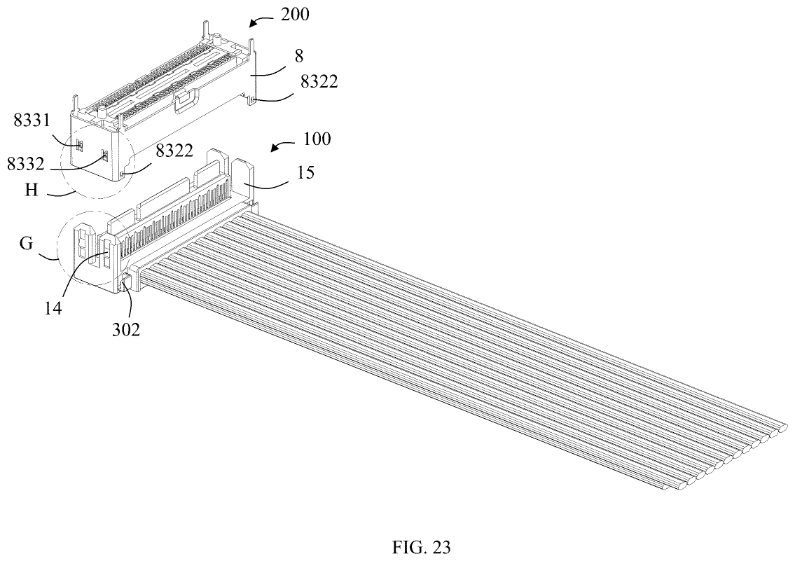

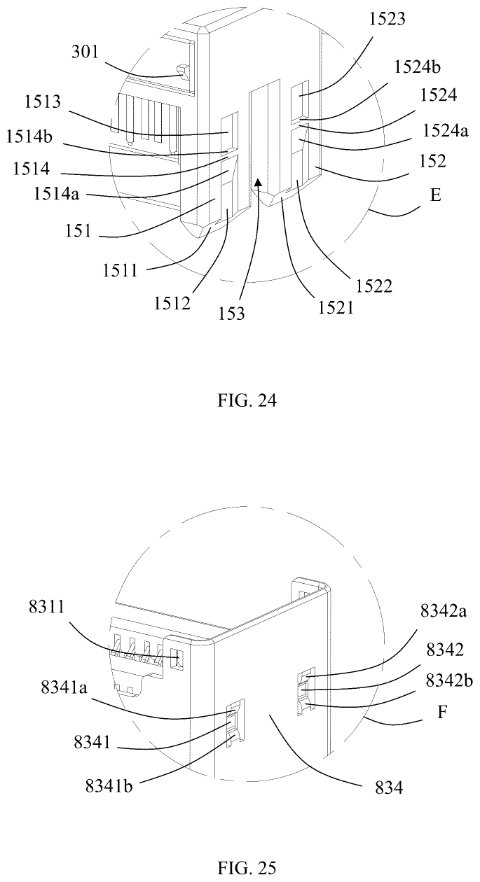

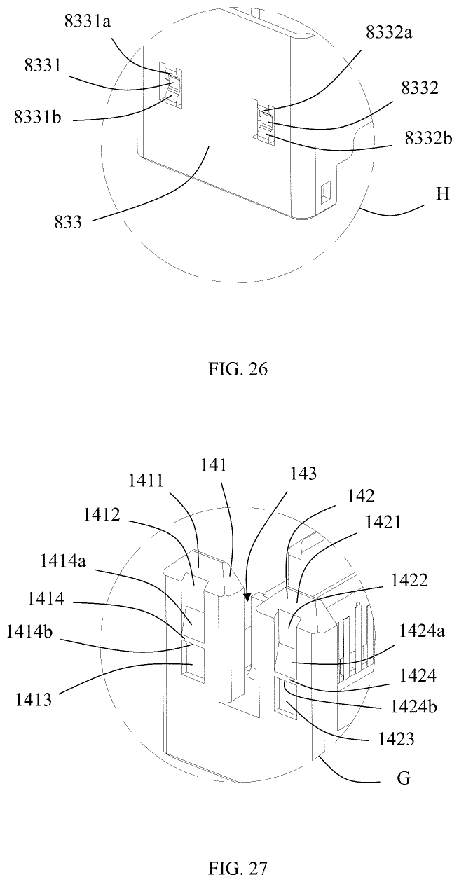

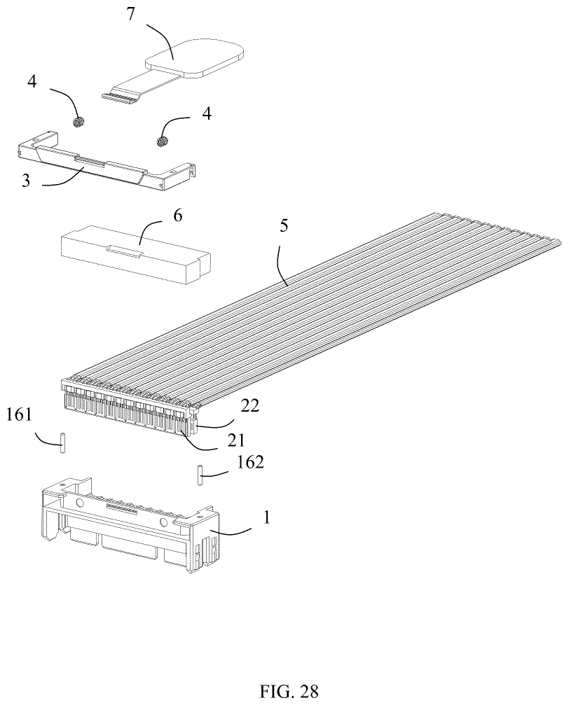

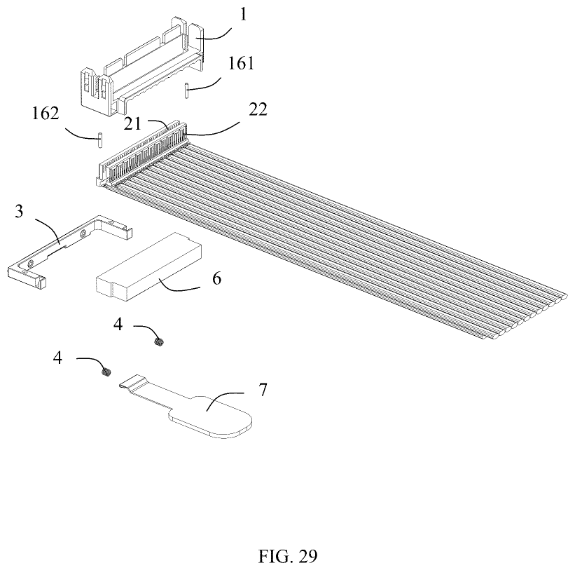

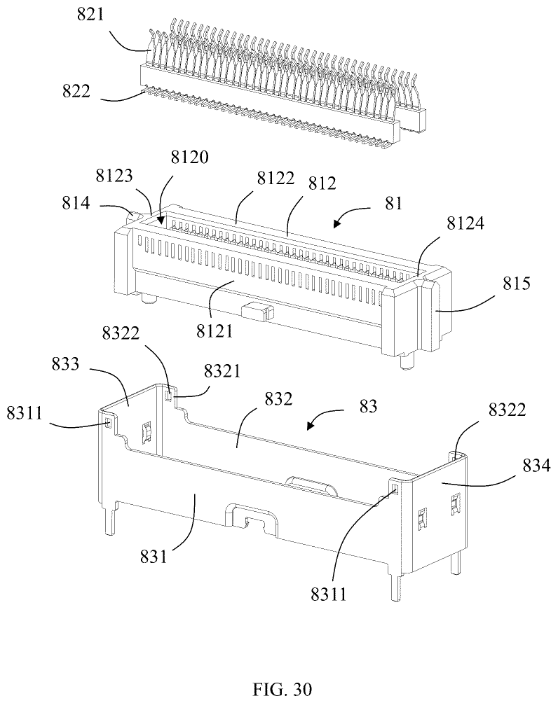

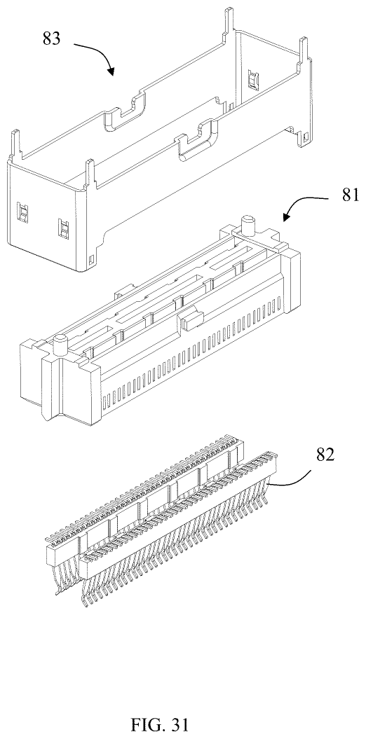

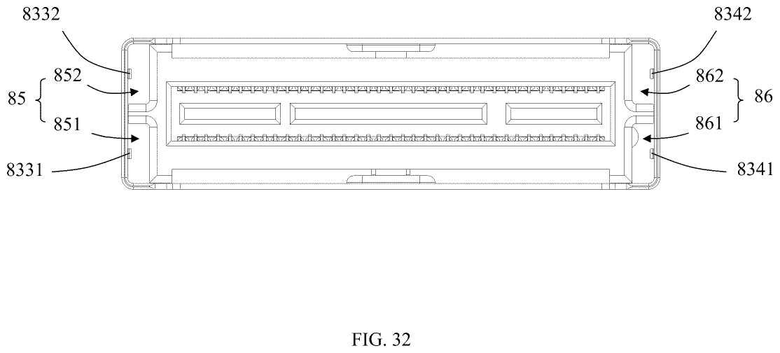

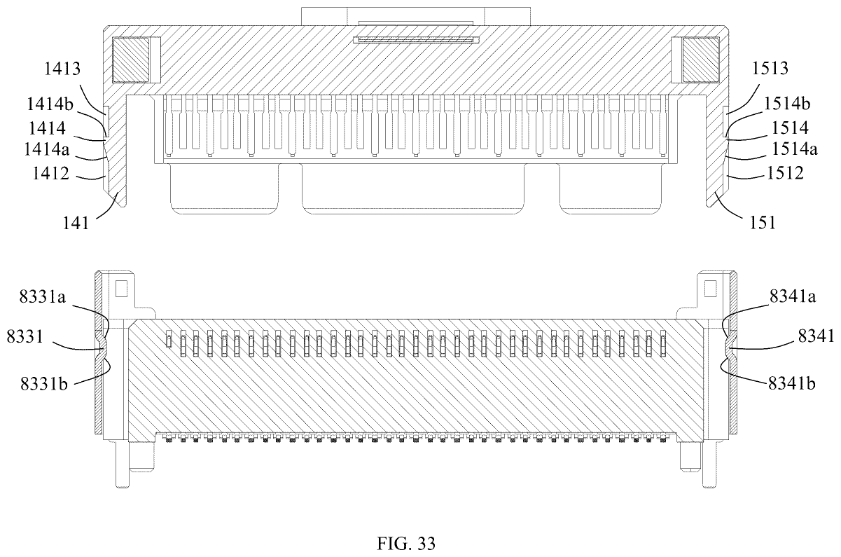

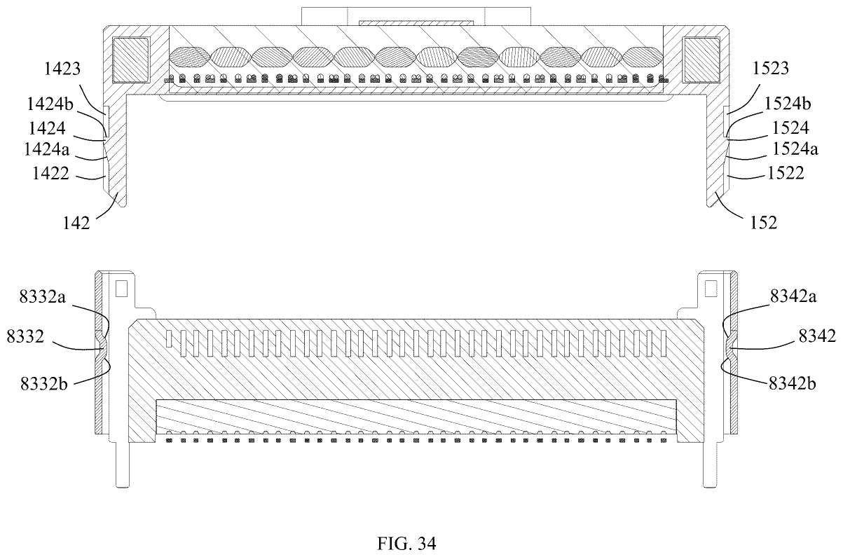

Referring to FIG. 16 to FIG. 34, a second embodiment of the present disclosure discloses an electrical connector assembly, which includes an electrical connector 100 and a mating connector 200 for mating with the electrical connector 100. In the second illustrated embodiment of the present disclosure, the electrical connector 100 is a cable connector. The mating connector 200 is a board-end connector configured to be installed on a circuit board 300. The electrical connector 100 is configured to mate with the mating connector 200 along a mating direction B (for example, a top-to-bottom direction) to achieve data transmission. The electrical connector 100 in the second embodiment of the present disclosure has a similar structure to the electrical connector 100 in the first embodiment. For the electrical connector 100 in the second embodiment of the present disclosure, reference may be made to the description of the electrical connector 100 in the first embodiment, where the same reference numerals represent the same or corresponding technical features. The mating connector 200 in the second embodiment of the present disclosure has a similar structure to the mating connector 200 in the first embodiment. For the mating connector 200 in the second embodiment of the present disclosure, reference may be made to the description of the mating connector 200 in the first embodiment, where the same reference numerals represent the same or corresponding technical features.

The electrical connector 100 in the second embodiment of the present disclosure is briefly described as follows. It includes an insulating body 1, a plurality of conductive terminals 2 fixed to the insulating body 1, a movable component 3 installed on the insulating body 1, an elastic component 4 abutting against the movable component 3, a cable 5 electrically connected to the conductive terminal 2, a cover plate 6 fastened on the insulating body 1 and at least partially abuts against the cable 5, a pull strap 7 connected to the movable component 3.

The electrical connector 100 in the second embodiment of the present disclosure is similar to the electrical connector 100 in the first embodiment. The main difference is that the insulating body 1 of the electrical connector 100 in the second embodiment of the present disclosure includes a main body 11, a tongue plate 12 extending downwardly from the main body 11 along the mating direction B, a positioning plate 13 further extending downwardly from the tongue plate 12 along the mating direction B, and a first extension portion 14 and a second extension portion 15 which extend downwardly from the main body 11 along the mating direction B.

In the second embodiment illustrated in the present disclosure, the first extension portion 14 and the second extension portion 15 are located on the left and right sides of the main body 11. The first extension portion 14 and the second extension portion 15 are integrally formed with the main body 11. The first extension portion 14 includes a first extension protrusion 141, a second extension protrusion 142, and a first slot 143 located between the first extension protrusion 141 and the second extension protrusion 142. In the second embodiment illustrated in the present disclosure, the first extension protrusion 141 and the second extension protrusion 142 are identical and symmetrically disposed on two sides of the first slot 143.

Specifically, the first extension protrusion 141 includes a first guide inclined surface 1411 located at a free end thereof, a first recessed groove 1412 extending downwardly through the first guide inclined surface 1411 along the mating direction B, a first retaining groove 1413 spaced apart from the first recessed groove 1412 along the mating direction B, and a first partition wall 1414 located between the first recessed groove 1412 and the first retaining groove 1413 along the mating direction B. In the second embodiment illustrated in the present disclosure, a portion of the first partition wall 1414 exposed in the first recessed groove 1412 is provided with a first inclined surface 1414a. Another portion of the first partition wall 1414 exposed in the first retaining groove 1413 is provided with a first flat surface 1414b.

The second extension protrusion 142 includes a second guide inclined surface 1421 located at a free end thereof, a second recessed groove 1422 extending downwardly through the second guide inclined surface 1421 along the mating direction B, a second retaining groove 1423 spaced apart from the second recessed groove 1422 along the mating direction B, and a second partition wall 1424 located between the second recessed groove 1422 and the second retaining groove 1423 along the mating direction B. In the second embodiment illustrated in the present disclosure, a portion of the second partition wall 1424 exposed in the second recessed groove 1422 is provided with a second inclined surface 1424a. Another portion of the second partition wall 1424 exposed in the second retaining groove 1423 is provided with a second flat surface 1424b.

The second extension portion 15 includes a third extension protrusion 151, a fourth extension protrusion 152, and a second slot 153 located between the third extension protrusion 151 and the fourth extension protrusion 152. In the second embodiment illustrated in the present disclosure, the third extension protrusion 151 and the fourth extension protrusion 152 are identical and symmetrically disposed on two sides of the second slot 153.

Specifically, the third extension protrusion 151 includes a third guide inclined surface 1511 located at a free end thereof, a third recessed groove 1512 extending downwardly through the third guide inclined surface 1511 along the mating direction B, a third retaining groove 1513 spaced apart from the third recessed groove 1512 along the mating direction B, and a third partition wall 1514 is located between the third recessed groove 1512 and the third retaining groove 1513 along the mating direction B. In the second embodiment illustrated in the present disclosure, a portion of the third partition wall 1514 exposed in the third recessed groove 1512 is provided with a third inclined surface 1514a. Another portion of the third partition wall 1514 exposed in the third retaining groove 1513 is provided with a third flat surface 1514b.

The fourth extension protrusion 152 includes a fourth guide inclined surface 1521 located at a free end thereof, a fourth recessed groove 1522 extending downwardly along the mating direction B of the fourth guide inclined surface 1521, a fourth retaining groove 1523 spaced apart from the fourth recessed groove 1522 along the mating direction B, and a fourth partition wall 1524 located between the fourth recessed groove 1522 and the fourth retaining groove 1523 along the mating direction B. In the second embodiment illustrated in the present disclosure, a portion of the fourth partition wall 1524 exposed in the fourth recessed groove 1522 is provided with a fourth inclined surface 1524a. Another portion of the fourth partition wall 1524 exposed in the fourth retaining groove 1523 is provided with a fourth flat surface 1524b.

In the second embodiment of the disclosure, the first retaining groove 1413, the second retaining groove 1423, the third retaining groove 1513 and the fourth retaining groove 1523 are all rectangular. The first retaining groove 1413, the second retaining groove 1423, the third retaining groove 1513 and the fourth retaining groove 1523 serve as a first locking structure, a second locking structure, a third locking structure and a fourth locking structure, respectively, to lock with the mating connector 200. Of course, it is understandable to those skilled in the art that the first locking structure, the second locking structure, the third locking structure and the fourth locking structure can also adopt other forms (for example, locking protrusions) to lock with the mating connector 200.

In the second embodiment of the present disclosure, the mating connector 200 includes a mating insulating body 81, a plurality of mating terminals 82 fixed to the mating insulating body 81, and a metal shell 83 enclosing the mating insulating body 81. The mating insulating body 81 includes a bottom wall 811 and a plurality of wall portions 812 perpendicular to the bottom wall 811.

In the second embodiment of the present disclosure, the plurality of wall portions 812 include a first wall portion 8121, a second wall portion 8122 disposed opposite to the first wall portion 8121, a first connecting wall portion 8123 connecting one side of the first wall portion 8121 and one side of the second wall portion 8122, and a second connecting wall portion 8124 connecting another side of the first wall portion 8121 and another side of the second wall portion 8122. The mating insulating body 81 further includes first protrusion 814 extending from the first connecting wall portion 8123 in a left-right direction/a first direction away from the second connecting wall portion 8124, and a second protrusion 815 extending from the second connecting wall portion 8124 in the left-right direction away from the first connecting wall portion 8123.

In the second embodiment of the present disclosure, the first wall portion 8121 corresponds to the first side wall 831, the second wall portion 8122 corresponds to the second side wall 832, the first connecting wall portion 8123 corresponds to the first connecting wall 833, and the second connecting wall portion 8124 corresponds to the second connecting wall 834. The mating connector 200 includes a first accommodating groove 85 located between the metal shell 83 and the mating insulating body 81, and a second accommodating groove 86 located between the metal shell 83 and the mating insulating body 81.

In the second embodiment illustrated of the present disclosure, the first accommodating groove 85 is located between the first connecting wall portion 8123 and the first connecting wall 833 in the left-right direction. The first protrusion 814 is located between the first connecting wall portion 8123 and the first connecting wall 833 along a front-rear direction/a second direction. The first protrusion 814 divides the first accommodating groove 85 into a first accommodating sub-groove 851 and a second accommodating sub-groove 852.

Similarly, in the second illustrated embodiment of the present disclosure, the second accommodating groove 86 is located between the second connecting wall portion 8124 and the second connecting wall 834 along the left-right direction. The second protrusion 815 is located between the second connecting wall portion 8124 and the second connecting wall 834 in the front-rear direction. The second protrusion 815 divides the second accommodating groove 86 into a third accommodating sub-groove 861 and a fourth accommodating sub-groove 862.

In the second embodiment of the present disclosure, the first connecting wall 833 includes a first locking protrusion 8331 protruding inwardly into the first accommodating sub-groove 851 and a second locking protrusion 8332 protruding inwardly into the second accommodating sub-groove 852. In the second embodiment of the present disclosure, the first locking protrusion 8331 and the second locking protrusion 8332 are stamped inwardly from the first connecting wall 833. In the second embodiment of the present disclosure, the first locking protrusion 8331 and the second locking protrusion 8332 are simply supported beams, that is, two ends thereof are both connected to the first connecting wall 833 to provide sufficient rigidity. In the second embodiment illustrated in the present disclosure, the first locking protrusion 8331 is provided with a first insertion guide portion 8331a and a first extraction guide portion 8331b which are located at two ends thereof, respectively. The second locking protrusion 8332 is provided with a second insertion guide portion 8332a and a second extraction guide portion 8332b which are located at two ends thereof, respectively.

Similarly, in the second embodiment of the present disclosure, the second connecting wall 834 includes a third locking protrusion 8341 protruding inwardly into the third accommodating sub-groove 861 and a fourth locking protrusion 8342 protruding inwardly into the fourth accommodating sub-groove 862. In the second embodiment illustrated in the present disclosure, the third locking protrusion 8341 and the fourth locking protrusion 8342 are stamped inwardly from the second connecting wall 834. In the second embodiment of the disclosure, the third locking protrusion 8341 and the fourth locking protrusion 8342 are simply supported beams, that is, two ends thereof are both connected to the second connecting wall 834 to provide sufficient rigidity. In the second embodiment illustrated in the present disclosure, the third locking protrusion 8341 is provided with a third insertion guide portion 8341a and a third extraction guide portion 8341b which are located at two ends thereof, respectively. The fourth locking protrusion 8342 is provided with a fourth insertion guide portion 8342a and a fourth extraction guide portion 8342b which are located at two ends thereof, respectively.

In the second embodiment of the present disclosure, the first insertion guide portion 8331a, the second insertion guide portion 8332a, the third insertion guide portion 8341a and the fourth insertion guide portion 8342a are all inclined surfaces or arc-shaped surfaces. When the electrical connector 100 is inserted into the mating connector 200, the first insertion guide portion 8331a, the second insertion guide portion 8332a, the third insertion guide portion 8341a and the fourth insertion guide portion 8342a are configured to abut against the first partition wall 1414, the second partition wall 1424, the third partition wall 1514 and the fourth partition wall 1524, respectively, so that the first locking protrusion 8331, the second locking protrusion 8332, the third locking protrusion 8341 and the fourth locking protrusion 8342 can smoothly cross the first partition wall 1414, the second partition wall 1424, the third partition wall 1514 and the fourth partition wall 1524, respectively, so as to be locked in the first retaining groove 1413, the second retaining groove 1423, the third retaining groove 1513 and the fourth retaining groove 1523, respectively. In the second embodiment of the present disclosure, the first retaining groove 1413, the second retaining groove 1423, the third retaining groove 1513 and the fourth retaining groove 1523 are respectively adapted to the first locking protrusion 8331, the second locking protrusion 8332, the third locking protrusion 8341 and the fourth locking protrusion 8342, respectively, so as to reduce shaking and improve mating stability when the first locking protrusion 8331, the second locking protrusion 8332, the third locking protrusion 8341 and the fourth locking protrusion 8342 are respectively locked in the first retaining groove 1413, the second retaining groove 1423, the third retaining groove 1513 and the fourth retaining groove 1523, respectively.

Similarly, in the second illustrated embodiment of the present disclosure, the first extraction guide portion 8331b, the second extraction guide portion 8332b, the third extraction guide portion 8341b and the fourth extraction guide portion 8342b are inclined surfaces or arc-shaped surfaces. When the electrical connector 100 is pulled out from the mating connector 200, the first extraction guide portion 8331b, the second extraction guide portion 8332b, the third extraction guide portion 8341b and the fourth extraction guide portion 8342b abut against the first partition wall 1414, the second partition wall 1424, the third partition wall 1514, and the fourth partition wall 1524, respectively, so that the first locking protrusion 8331, the second locking protrusion 8332, the third locking protrusion 8341 and the fourth locking protrusion 8342 can smoothly cross the first partition wall 1414, the second partition wall 1424, the third partition wall 1514 and the fourth partition wall 1524, respectively, and enter the first recessed groove 1412, the second recessed groove 1422, the third recessed groove 1512 and the fourth recessed groove 1522, respectively, to achieve unlocking on both the left and right sides.

Besides, when the electrical connector 100 is inserted into the mating connector 200, the positioning plate 13 is correspondingly inserted into the positioning groove 8110, the tongue plate 12 is correspondingly inserted into the mating slot 8120, and the mating portions 21 of the conductive terminals 2 are in contact with the elastic mating arms 821 of the mating terminals 82. When the electrical connector 100 is inserted into the mating connector 200, the inclined surface of the first locking protrusion 301 and the inclined surface of the second locking protrusion 302 abut against the first side wall 831 and the second side wall 832, respectively. The movable component 3 overcomes a force of the elastic component 4 and moves inwardly for a certain distance along the moving direction C. When the first locking protrusion 301 and the second locking protrusion 302 move downwardly to correspond to the first locking hole 8311 and the second locking hole 8322, respectively, the elastic component 4 recovers its elastic force, causing the movable component 3 to return in a direction opposite to the moving direction C. At this time, both the first locking protrusion 301 and the second locking protrusion 302 protrude forwardly into the first locking hole 8311 and the second locking hole 8322, respectively, to realize the locking of the electrical connector 100 and the mating connector 200 at the front and rear sides.

At the same time, when the electrical connector 100 is inserted into the mating connector 200, the first extension protrusion 141 is inserted into the first accommodating sub-groove 851 under the guidance of the first guide inclined surface 1411, the second extension protrusion 142 is inserted into the second accommodating sub-groove 852 under the guidance of the second guide inclined surface 1421, the third extension protrusion 151 is inserted into the third accommodating sub-groove 861 under the guidance of the third guide inclined surface 1511, and the fourth extension protrusion 152 is inserted into the fourth accommodating sub-groove 862 under the guidance of the fourth guide inclined surface 1521. The first locking protrusion 8331 enters the first recessed groove 1412 and crosses the first recessed groove 1412 under the guidance of the first inclined surface 1414a to be locked into the first retaining groove 1413. The second locking protrusion 8332 enters the second recessed groove 1422 and crosses the second recessed groove 1422 under the guidance of the second inclined surface 1424a to be locked in the second retaining groove 1423. The third locking protrusion 8341 enters the third recessed groove 1512 and crosses the third recessed groove 1512 under the guidance of the third inclined surface 1514a to be locked in the third retaining groove 1513. The fourth locking protrusion 8342 enters the fourth recessed groove 1522 and crosses the fourth recessed groove 1522 under the guidance of the fourth inclined surface 1524a to be locked in the fourth retaining groove 1523. Finally, the electrical connector 100 and the mating connector 200 realize locking on both the left and right sides.

It is understandable to those skilled in the art that when the electrical connector 100 is inserted into the mating connector 200 and inserted in place, the first protrusion 814 and the second protrusion 815 of the mating connector 200 are clamped in the first slot 143 and the second slot 153 of the electrical connector 100, respectively. With the height of the first protrusion 814 and the second protrusion 815 in the mating direction B, the first protrusion 814 and the second protrusion 815 can prevent the electrical connector 100 from tilting due to an external force, thereby improving the mating reliability. It is understandable to those skilled in the art that in the second embodiment of the present disclosure, the first protrusion 814 and the second protrusion 815 are integrally formed with the first connecting wall portion 8123 and the third connecting wall portion 8123, respectively. Of course, in other embodiments, the first protrusion 814 and the second protrusion 815 may also be provided separately from the mating insulating body 81, and fixed to the mating insulating body 81 and/or the metal shell 83, which will not be described again in the present disclosure.

In the present disclosure, by providing the first locking protrusion 301 and the second locking protrusion 302 on the two sides, the two-side locking in the front-rear direction/the second direction can be achieved, thereby improving the mating reliability and reducing the risk of the electrical connector 100 and the mating connector 200 becoming loose or tilted. In addition, by having the first locking protrusion 8331, the second locking protrusion 8332, the third locking protrusion 8341 and the fourth locking protrusion 8342 respectively locked in the first retaining groove 1413, the second retaining groove 1423, the third retaining groove 1513 and the fourth retaining groove 1523, the two-side locking in the left and right direction/the first direction can be realized, which further improves the mating reliability and further reduces the risk of the electrical connector 100 and the mating connector 200 becoming loose or tilted.

When the electrical connector 100 and the mating connector 200 need to be unlocked, an external force is applied to pull the pull strap 7, and the pull strap 7 generates a component force along the moving direction C, and the component force in this direction overcomes the force of the elastic component 4, so that the movable component 3 moves along the moving direction C. The first ejector rod 32 and the second ejector rod 33 move away from the insertion plate portion 8321 backwards, so that the second locking protrusion 302 and the second locking hole 8322 are disengaged from each other. The first locking protrusion 301 and the first locking hole 8311 are also separated from each other.

Besides, during the unlocking process, the first locking protrusion 8331, the second locking protrusion 8332, the third locking protrusion 8341 and the fourth locking protrusion 8342 respectively cross the first partition wall 1414, the second partition wall 1424, the third partition wall 1514 and the fourth partition wall 1524, under the guidance of the first extraction guide portion 8331b, the second extraction guide portion 8332b, the third extraction guide portion 8341b and the fourth extraction guide portion 8342b, so as to achieve unlocking.

In other words, at this time, the electrical connector 100 and the mating connector 200 complete the unlocking on both sides of the left-right direction/the first direction and the unlocking on both sides of the front-rear direction/the second direction. The electrical connector 100 can be pulled out of the mating connector 200 by applying another force or by exerting an upward force component on the pull strap 7.

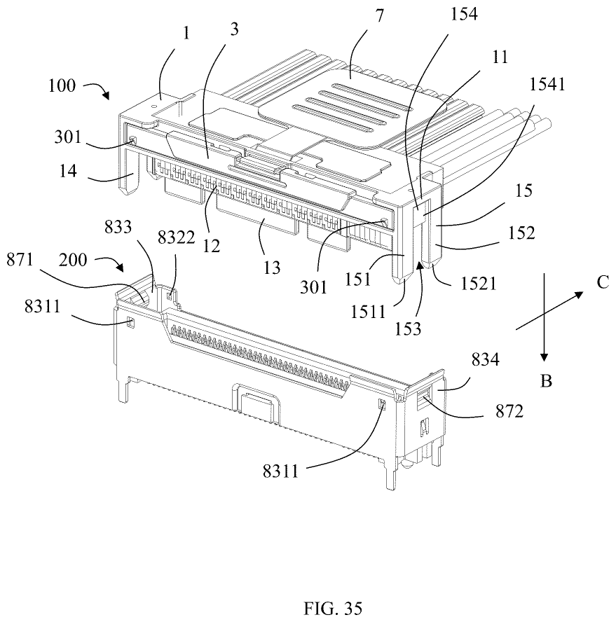

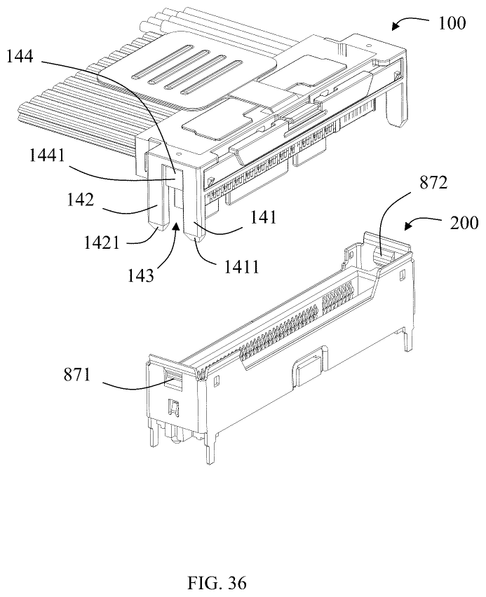

Referring to FIG. 35 and FIG. 36, in a third embodiment of the present disclosure, the electrical connector 100 is similar to the electrical connector 100 in the second embodiment, where the same reference numerals represent the same or corresponding technical features.

The main differences between the electrical connector 100 in the third embodiment of the present disclosure and the electrical connector 100 in the second embodiment of the present disclosure are as follows:
in the third embodiment of the present disclosure, the insulating body 1 of the electrical connector 100 includes a main body 11, and a first extension portion 14 and the second extension portion 15 which extend downwardly from the main body 11. The first extension portion 14 includes a first extension protrusion 141, a second extension protrusion 142, and a first slot 143 located between the first extension protrusion 141 and the second extension protrusion 142. The second extension portion 15 includes a third extension protrusion 151, a fourth extension protrusion 152, and a second slot 153 located between the third extension protrusion 151 and the fourth extension protrusion 152. The first extension protrusion 141 includes a first guide inclined surface 1411 located at a free end thereof. The second extension protrusion 142 includes a second guide inclined surface 1421 at a free end thereof. The third extension protrusion 151 includes a third guide inclined surface 1511 located at a free end thereof. The fourth extension protrusion 152 includes a fourth guide inclined surface 1521 located at a free end thereof. However, in the third embodiment of the present disclosure, the first extension protrusion 141, the second extension protrusion 142, the third extension protrusion 151 and the fourth extension protrusion 152 are not provided with structures such as recessed grooves, retaining grooves and partition walls as in the second embodiment. In addition, in the third embodiment of the present disclosure, the first extension portion 14 includes a first recessed portion 144 located between the first extension protrusion 141 and the second extension protrusion 142, and located above the first slot 143. The first recessed portion 144 is provided with a recessed first contact surface 1441. Similarly, the second extension portion 15 includes a second recessed portion 154 located between the third extension protrusion 151 and the fourth extension protrusion 152, and located above the second slot 153. The second recessed portion 154 is provided with a recessed second contact surface 1541.

Referring to FIG. 35 and FIG. 36, in the third embodiment of the present disclosure, the mating connector 200 is similar to the mating connector 200 in the second embodiment, where the same reference numerals represent the same or corresponding technical features.

The main differences between the mating connector 200 in the third embodiment of the present disclosure and the mating connector 200 in the second embodiment of the present disclosure are as follows:
in the third embodiment of the present disclosure, the metal shell 83 of the mating connector 200 is not provided with the first locking protrusion 8331, the second locking protrusion 8331, the third locking protrusion 8341 and the fourth locking protrusion 8342 that protrude into the first accommodating sub-groove 851, the second accommodating sub-groove 852, the third accommodating sub-groove 861 and the fourth accommodating sub-groove 862, respectively. On the contrary, the metal shell 83 of the mating connector 200 in the third embodiment of the present disclosure is provided with a first abutting tab 871 and a second abutting tab 872 that are stamped inwardly.

When the electrical connector 100 is inserted into the mating connector 200, the first extension protrusion 141 is inserted into the first accommodating sub-groove 851 under the guidance of the first guide inclined surface 1411, the second extension protrusion 142 is inserted into the second accommodating sub-groove 852 under the guidance of the second guide inclined surface 1421, the third extension protrusion 151 is inserted into the third accommodating sub-groove 861 under the guidance of the third guide inclined surface 1511, and the fourth extension protrusion 152 is inserted into the fourth accommodating sub-groove 862 under the guidance of the fourth guide inclined surface 1521. When the electrical connector 100 is inserted in place, the first abutting tab 871 abuts against the first contact surface 1441, and the second abutting tab 872 abuts against the second contact surface 1541. Two sides of the electrical connector 100 are limited between the first connecting wall 833 and the second connecting wall 834 of the mating connector 200 in the left-right direction. The locking structures of the electrical connector 100 and the mating connector 200 are realized by the locking structures located on the front and rear sides. The locking structures are the same as the locking structures disclosed in the second embodiment of the present disclosure, and will not be described again herein.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body comprising a main body, a tongue plate protruding from the main body along a mating direction, and a first extension portion and the second extension portion which protrude from the main body along the mating direction; the first extension portion and the second extension portion being located on two sides of the main body; and
a plurality of conductive terminals, each conductive terminal comprising a mating portion exposed to the tongue plate;
wherein the first extension portion comprises a first extension protrusion, a second extension protrusion, and a first slot located between the first extension protrusion and the second extension protrusion;
the second extension portion comprises a third extension protrusion, a fourth extension protrusion, and a second slot located between the third extension protrusion and the fourth extension protrusion;
the first extension protrusion, the second extension protrusion, the third extension protrusion and fourth extension protrusion are configured to be at least partially inserted into a mating connector; the first slot and the second slot are configured to at least partially accommodate the mating connector, so that the electrical connector and the mating connector are engaged with each other.

2. The electrical connector according to claim 1, wherein the first extension protrusion defines a first retaining groove, the second extension protrusion defines a second retaining groove, the third extension protrusion defines a third retaining groove, and the fourth extension protrusion defines a fourth retaining groove; the first retaining groove, the second retaining groove, the third retaining groove and the fourth retaining groove are configured to lock with a first locking protrusion, a second locking protrusion, a third locking protrusion and a fourth locking protrusion of the mating connector, respectively.

3. The electrical connector according to claim 2, wherein the first extension protrusion comprises a first guide inclined surface and a first recessed groove extending through the first guide inclined surface along the mating direction; the first retaining groove is spaced apart from the first recessed groove along the mating direction; the first extension protrusion further comprises a first partition wall located between the first recessed groove and the first retaining groove along the mating direction.

4. The electrical connector according to claim 3, wherein a portion of the first partition wall exposed in the first recessed groove is provided with a first inclined surface, and the first inclined surface is configured to guide the first locking protrusion to cross the first partition wall so as to be locked in the first retaining groove.

5. The electrical connector according to claim 2, wherein the second extension protrusion comprises a second guide inclined surface and a second recessed groove extending through the second guide inclined surface along the mating direction; the second retaining groove is spaced apart from the second recessed groove along the mating direction; the second extension protrusion further comprises a second partition wall located between the second recessed groove and the second retaining groove along the mating direction.

6. The electrical connector according to claim 5, wherein a portion of the second partition wall exposed in the second recessed groove is provided with a second inclined surface, and the second inclined surface is configured to guide the second locking protrusion to cross the second partition wall so as to be locked in the second retaining groove.

7. The electrical connector according to claim 2, wherein the third extension protrusion comprises a third guide inclined surface and a third recessed groove extending through the third guide inclined surface along the mating direction; the third retaining groove is spaced apart from the third recessed groove along the mating direction; the third extension protrusion further comprises a third partition wall located between the third recessed groove and the third retaining groove along the mating direction.

8. The electrical connector according to claim 7, wherein a portion of the third partition wall exposed in the third recessed groove is provided with a third inclined surface, and the third inclined surface is configured to guide the third locking protrusion to cross the third partition wall so as to be locked in the third retaining groove.

9. The electrical connector according to claim 2, wherein the fourth extension protrusion comprises a fourth guide inclined surface and a fourth recessed groove extending through the fourth guide inclined surface along the mating direction; the fourth retaining groove is spaced apart from the fourth recessed groove along the mating direction; the fourth extension protrusion further comprises a fourth partition wall located between the fourth recessed groove and the fourth retaining groove along the mating direction.

10. The electrical connector according to claim 9, wherein a portion of the fourth partition wall exposed in the fourth recessed groove is provided with a fourth inclined surface, and the fourth inclined surface is configured to guide the fourth locking protrusion to cross the fourth partition wall so as to be locked in the fourth retaining groove.

11. The electrical connector according to claim 1, wherein the first slot and the second slot are configured to receive a first protrusion and a second protrusion of the mating connector, respectively.

12. The electrical connector according to claim 1, wherein the main body comprises a first end wall and a second end wall disposed opposite to the first end wall;
the electrical connector further comprises:
a movable component at least partially installed on the main body, the movable component comprising a first locking protrusion protruding beyond the first end wall, an ejector rod extending from the first end wall towards the second end wall, and a second locking protrusion protruding beyond the ejector rod; a rear end of the ejector rod protruding beyond the second end wall; the first locking protrusion and the second locking protrusion being configured to lock with locking holes of a mating connector;
an elastic component abutting against the movable component; and
a pull strap connected to the movable component; the pull strap being configured to drive the movable component to overcome a force of the elastic component, so that the movable component moves along a moving direction perpendicular to the mating direction.

13. The electrical connector according to claim 12, wherein the ejector rod comprises a groove portion; the groove portion comprises a first blocking wall and a second blocking wall which are disposed face to face; the second locking protrusion protrudes from the first blocking wall toward the second blocking wall, and the second locking protrusion is spaced from the second blocking wall by a distance.

14. The electrical connector according to claim 12, wherein the main body comprises a fixing plate located between the first end wall and the second end wall; the fixing plate comprises a pull strap groove extending through the fixing plate along the moving direction, and a pull strap shaft located between an edge of the fixing plate and the pull strap groove; and
wherein the pull strap extends from a connection between the pull strap and the movable component and passes through the pull strap groove along the moving direction, and the pull strap is bent along the pull strap shaft and then extends out of the main body.

15. The electrical connector according to claim 12, wherein the main body defines a receiving space extending through the first end wall, a first receiving groove located on a side of the receiving space, and a second receiving groove located on another side of the receiving space; the first receiving groove and the second receiving groove extend through the second end wall along the moving direction; and
wherein the movable component comprises a base received in the receiving space; the ejector rod comprises a first ejector rod extending from a side of the base and a second ejector rod extending from another side of the base; the first ejector rod is partially accommodated in the first receiving groove except a rear end of the first ejector rod which extends out of the first receiving groove; the second ejector rod is partially accommodated in the second receiving groove except a rear end of the second ejector rod which extends out of the second receiving groove.

16. A mating connector, comprising:
a mating insulating body, the mating insulating body comprising a plurality of wall portions and a mating slot surrounded by the plurality of wall portions; the plurality of wall portions comprising a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive an electrical connector;
a plurality of mating terminals, the plurality of mating terminals being fixed to the mating insulating body; each mating terminal comprising an elastic mating arm extending into the mating slot and being configured to contact the electrical connector; and
a metal shell, the metal shell at least partially covering the mating insulating body; the metal shell comprising a first side wall, a second side wall disposed opposite to the first side wall, a first connecting wall connecting one side of the first side wall and one side of the second side wall, and a second connecting wall connecting another side of the first side wall and another side of the second side wall;
wherein the mating connector defines a first accommodating groove located between the first connecting wall portion and the first connecting wall, and a second accommodating groove located between the second connecting wall portion and the second connecting wall;
the mating connector comprises a first protrusion located in the first accommodating groove; the first protrusion divides the first accommodating groove into a first accommodating sub-groove and a second accommodating sub-groove;
the mating connector comprises a second protrusion located in the second accommodating groove; the second protrusion divides the second accommodating groove into a third accommodating sub-groove and a fourth accommodating sub-groove;
the first accommodating sub-groove, the second accommodating sub-groove, the third accommodating sub-groove and the fourth accommodating sub-groove are configured to at least partially receive the electrical connector.

17. The mating connector according to claim 16, wherein the first protrusion and the second protrusion are both provided on the mating insulating body; the first protrusion integrally extends from the first connecting wall portion away from the second connecting wall portion; and the second protrusion integrally extends from the second connecting wall portion away from the first connecting wall portion.

18. The mating connector according to claim 16, wherein the first connecting wall is provided with a first locking protrusion protruding inwardly into the first accommodating sub-groove, and a second locking protrusion protruding inwardly into the second accommodating sub-groove;
the second connecting wall is provided with a third locking protrusion protruding inwardly into the third accommodating sub-groove, and a fourth locking protrusion protruding inwardly into the fourth accommodating sub-groove;
the first locking protrusion, the second locking protrusion, the third locking protrusion and the fourth locking protrusion are configured to lock with the electrical connector.

19. The mating connector according to claim 18, wherein the first locking protrusion and the second locking protrusion are both simply supported beams; the first locking protrusion is provided with a first insertion guide portion and a first extraction guide portion located at two ends thereof; the second locking protrusion is provided with a second insertion guide portion and a second extraction guide portion located at two ends thereof;
the third locking protrusion and the fourth locking protrusion are both simply supported beams; the third locking protrusion is provided with a third insertion guide portion and a third extraction guide portion located at two ends thereof; the fourth locking protrusion is provided with a fourth insertion guide portion and a fourth extraction guide portion located at two ends thereof.

20. An electrical connector assembly, comprising:
an electrical connector, the electrical connector, comprising:
an insulating body, the insulating body comprising a main body, a tongue plate protruding beyond the main body along a mating direction, and a first extension portion and the second extension portion which protrude beyond the main body along the mating direction; the first extension portion and the second extension portion being located on two sides of the main body, respectively; and
a plurality of conductive terminals, each conductive terminal comprising a mating portion exposed to the tongue plate;
wherein the first extension portion comprises a first extension protrusion, a second extension protrusion, and a first slot located between the first extension protrusion and the second extension protrusion;
the second extension portion comprises a third extension protrusion, a fourth extension protrusion, and a second slot located between the third extension protrusion and the fourth extension protrusion; and
a mating connector, the mating connector, comprising:
a mating insulating body, the mating insulating body comprising a plurality of wall portions and a mating slot surrounded by the plurality of wall portions; the plurality of wall portions comprising a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive the electrical connector;
a plurality of mating terminals, the plurality of mating terminals being fixed to the mating insulating body; each mating terminal comprising an elastic mating arm extending into the mating slot and being configured to contact the mating portion of the electrical connector; and
a metal shell, the metal shell at least partially covering the mating insulating body; the metal shell comprising a first side wall, a second side wall disposed opposite to the first side wall, a first connecting wall connecting one side of the first side wall and one side of the second side wall, and a second connecting wall connecting another side of the first side wall and another side of the second side wall;
wherein the mating connector defines a first accommodating groove located between the first connecting wall portion and the first connecting wall, and a second accommodating groove located between the second connecting wall portion and the second connecting wall;
the mating connector comprises a first protrusion located in the first accommodating groove; the first protrusion divides the first accommodating groove into a first accommodating sub-groove and a second accommodating sub-groove;
the mating connector comprises a second protrusion located in the second accommodating groove; the second protrusion divides the second accommodating groove into a third accommodating sub-groove and a fourth accommodating sub-groove;
when the electrical connector is inserted into the mating connector, the first extension protrusion, the second extension protrusion, the third extension protrusion and the fourth extension protrusion of the electrical connector are at least partially inserted into the first accommodating sub-groove, the second accommodating sub-groove, the third accommodating sub-groove and the fourth accommodating sub-groove of the mating connector, respectively.
